(19) United States
(12) Patent Application Publication
(10) Pub. No.: US 2004/0103545 A1
(43) Pub. Date: Jun. 3, 2004

(54) Razor handle with improved grip

(75) Inventor: Paul R. Dansreau, Shelton, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/643,494

(22) Filed: Aug. 19, 2003

Related U.S. Application Data
(60) Provisional application No. 60/405,258, filed on Aug. 21, 2002.

(51) Int. Cl. B26B 21/14

(52) U.S. Cl. 30/526; 30/50

(57) ABSTRACT

A shaver handle has an outer layer made from a compressible elastomeric material and formed around an inner rigid core. The elongated outer layer is provided with a series of spaced fins having a substantially uniform aspect ratio D:T, wherein D is a depth of each individual fin viewed in a direction transverse to a longitudinal axis of the shaver handle and T is a thickness of each of the fins viewed in a direction parallel to the longitudinal axis, the aspect ratio is greater than the depth D.

### CROSS-REFERENCE TO RELATED APPLICATIONS

This application is entitled to the benefit of and incorporates by reference essential subject matter disclosed in Provisional Patent Application No. 60/405,258 filed on Aug. 21, 2002.

### FIELD OF THE INVENTION

The invention relates to a wet or safety razor. Particularly, the invention relates to an ergonomically formed handle provided with an improved grip structure for a wet or safety razor.

### BACKGROUND OF THE INVENTION

Numerous types of wet or safety razors (referred hereinafter as safety razors) are known and, typically, comprise a handle portion, at the front end of which a razor blade unit is disposed. A structure of the handle portion is critical for bringing a razor blade unit in a desired position characterized by an optimal shaving angle of one or multiple blades with respect to the surface of skin. However, many known types of handles permit the user to grasp the handle in numerous arbitrary positions that quite often do not correspond to the desired position. Recognizing this drawback, safety razors have been developed with improved ergonomic characteristics of the handle portion designed to minimize a possibility of an arbitrary grip and to ensure the proper position of a blade(s) with respect to the surface of skin.

For example, U.S. Pat. No. 5,031,319 discloses a handle having a central plane that, starting from the front end, has an essentially S-shaped curved configuration. While the handle, as disclosed in this patent, ensures well-defined, optimal positioning of the safety razor, the fingers can disadvantageously slip from the smooth curved surfaces.

U.S. Pat. No. 5,687,485 discloses an elongated handle with a Y-shaped yoke provided with a finger-orienting channel, which runs along the spine of the handle. The handle has a plurality of spaced ribs designed to provide an improved gripping surface for the user. A combination of the finger orienting channel and the ribbed handle improves the gripping contact and minimizes the number of arbitrary positions in which the user can hold a safety razor.

However, the Y-shaped handle is made from a nonelastomeric incompressible material negatively affecting contact between the fingers and the handle and amounting to a decrease in comfort to the user. Furthermore, despite the finger-orienting channel, the Y-shaped handle still permits the user to grip the handle in a variety of positions. Moreover, the size of the pads, an aspect ratio defined between the thickness of and the depth of each pad and the density, with which a plurality of pads is distributed along the handle, can contribute to an uncomfortable rotation of the hand holding the handle at an awkward angle to optimally orient a blade unit with respect to the surface of skin.

U.S. Pat. No. 5,890,296 discloses a plurality of gripping pads including an elastomeric plastic outer gripping layer and a rigid support layer. The gripping pads are crescent shaped and spaced from one another at a substantial distance. The density, with which the gripping pads are distributed over the outer gripping layer, as well as the pads' shape and size contribute to a poor contact between the handle and the fingertips, particularly, when the handle is used in a soapy and watery environment. Thus, although the gripping pads are made from an elastomeric compressible material, their shape and size cannot facilitate shaving.

Overall, it has been recognized that the size of individual pads, ribs or fins formed on a handle is critical to an improved grip. Also, densities, with which the ribs are distributed over a handle, and a shape of the handle are also critical to an improved grip that facilitates shaving with an increase in comfort to the user.

It is, therefore, desirable to provide a safety razor with a handle having improved ergonomic characteristics. Also, a handle provided with an arrangement of fins each of which is shaped and dimensioned to provide the user with an improved tactile feel is desired as well. A safety razor having a handle, which is shaped in such a manner that it ensures an optimal ergonomic grip by the user, is also desirable.

### SUMMARY OF THE INVENTION

The above and other objects are attained by the present invention including a safety razor which has a handle with improved ergonomic characteristics. In particular, the handle has a composite structure comprising a substantially rigid inner core of an injected molded thermoplastic, nonelastomeric material and a flexible layer of an ejected molded elastomeric material which covers the rigid inner core.

The flexible layer has an array of ribs extending along opposite sides of the handle and covering at least the central portion of the handle. The fins are arranged so that the density, with which the fins are formed per centimeter, and the spacing between adjacent fins are selected so as to provide an improved grip in a manner minimizing rotation of the handle in the hand of the user.

In accordance with an aspect of the invention, the fins have a substantially uniform aspect ratio D:T, wherein D is a depth of each individual fin viewed in a direction transverse to a longitudinal axis of the handle and T is a thickness of each of the fins viewed in a direction parallel to the longitudinal axis, the aspect ratio is greater than the depth D. The aspect ratio D:T varies so that the fins allow for a soft cushiony feel. As a result, a safety razor provided with the handle, as disclosed in this invention, provides the fingertips with an improved guidance of the safety razor and hence facilitates the positioning of a razor blade unit at an optimal angle with respect to the surface of skin.

The fins can either be grouped along preferred regions of a handle or extend sequentially one after another along the entire length of the handle. In accordance with one aspect of the invention, a central portion of the handle is provided with opposed indentations conveniently formed within side regions which will most probably be held by the fingertips of the user. The regions defined by the indentations can have an arrangement of fins shaped and sized in accordance with the invention or can have an array of ribs which have shapes and dimensions different from the shapes of the fins, as disclosed in this invention.

### BRIEF DESCRIPTION OF THE DRAWINGS

The above and other objects, features and advantages will become more readily apparent from the following description taken in conjunction with the following drawings, in which:

FIG.1 is a top isometric view of a safety razor in accordance with one embodiment of the invention;

FIG. 2 is a bottom isometric view of the safety razor shown in FIG. 1;

FIG. 3 is a top isometric view of a handle of the safety razor in accordance with another embodiment of the invention;

FIG. 4 is a top view of the handle shown in FIG. 3; and

FIG. 5 is a cross-sectional view of the handle shown in FIG. 4 and taken along lines A-A.

### DETAILED DESCRIPTION OF THE PREFERRED EMBODIMENTS

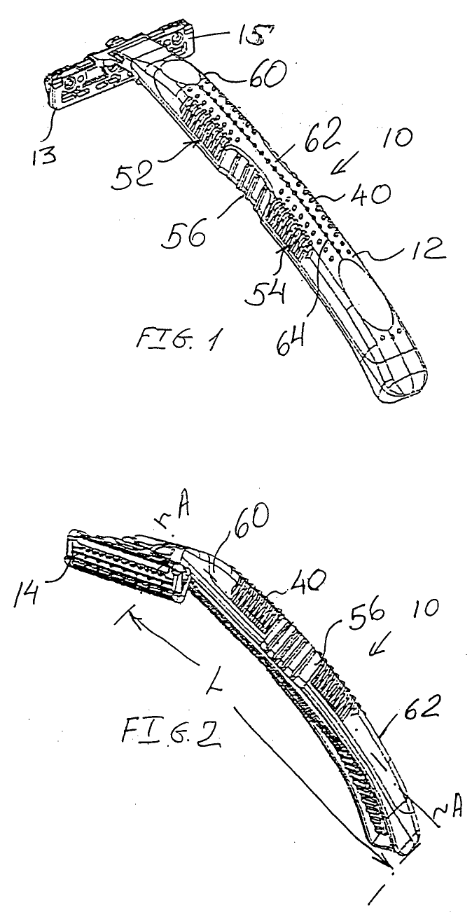

Referring to FIGS. 1-5, a safety razor 10 includes a gently curved handle 12 and a razor blade unit 15 having a plastic body 13 and provided with a single blade or multiple blades 14, which are fixedly embedded in the plastic body 13.

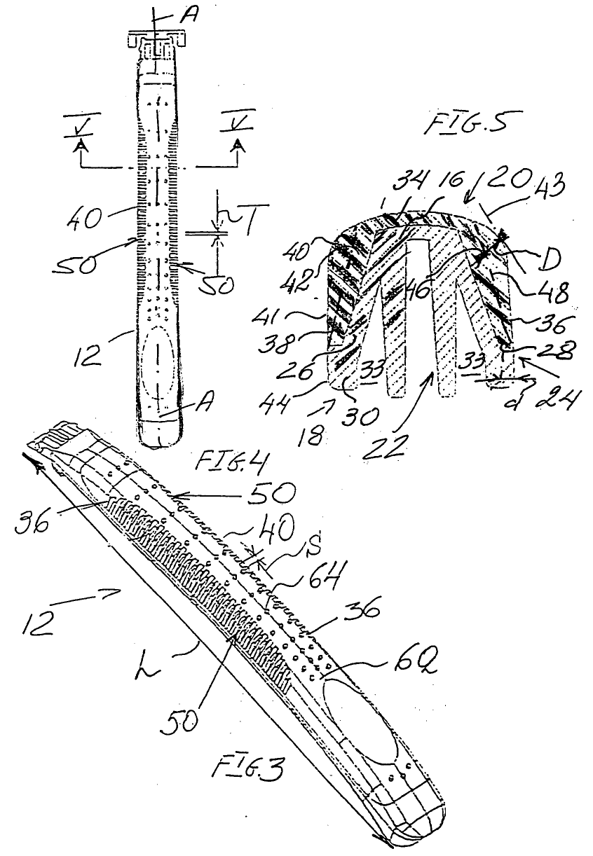

Referring specifically to FIGS.3, 4 and 5, the handle 12 has an inner, relatively incompressible core 18 made of a moldable nonelastomeric material and a relatively compressible layer 20 molded around the inner core 18 and having a relatively high degree of friction. The layer 20 is made from a moldable elastomeric material allowing for ample compression leading to security of the grip by the user while not requiring an excessive force. Accordingly, when gripped, the layer 20 tends to compress and, thus, to conform to the natural contour of the surface of the fingertips to provide a reliable contact between the handle 12 and the user. As a result, the handle 12 can be reliably held in a desired position, in which the razor blade unit 15 is oriented at an optimal shaving angle with respect to the surface of skin.

To be convenient in use, the handle 12 has to be light and at the same time resilient enough not to collapse under a compressing force applied by the user as he establishes contact with the handle 12. To meet these requirements, the inner core 18 extending in a direction of a longitudinal axis A-A (FIG. 4) has a central recessed portion 22, which has a U shape, and an outer, generally V-shaped portion 24. The central recessed 22 and outer 24 portions of the core 18 have a common outer part 16. The V-shaped outer portion 24 has a pair of legs 26 each of which extends angularly outwardly from the central portion 22 and inwardly from the outer part 16 toward a respective base 30 and, thus, forms the respective space 33 with the central recessed portion 22. As a result of these spaces 33, the weight of the relatively incompressible core 18 is reduced, and the part is more suitable for injection molding.

During molding, the compressible layer 20 is formed around the inner core 18 and has a continuous top segment 34 coextending with the outer part 16 of the inner core 18 and a pair of lateral segments 36 extending complementary to the legs 26 of the V-shaped portion 24. Each of the lateral segments 36 includes an axially continuous inner region 38 molded with a seat 28, which is formed in a respective one of the bases 30. A depth “d” of the seat 28 and a depth of the inner region 38 are substantially the same.

An array of axially spaced fins 40 is formed on each of the continuous inner regions 38 and extends laterally outwardly therefrom. Each fin 40 has a progressively decreasing depth as the fin 40 extends inward from the continuous top segment 34 of the layer 20 to the seat 28 of the base 30. An outer surface 41 of the fins 40 is preferably flushed with an outer surface 44 of the bases 30.

In use, an upper portion 42 of the fins 40 will be most likely held by the user who will exert a pressure thereupon. Accordingly, the upper portion 42 represents the deepest portion of the fins 40 and is preferably rounded so that it merges with the top segment 34 of the layer 20. The depth D of this rounded portion 42 is defined as a radial distance between a tangent 43 and a center of curvature 46, which lies on an outer extremity 48 of each inner region 38. If the depth D of the rounded portion 42 is greater than a desired or optimal depth, the user will have to apply an excessive force to compress the fins 40 in order to obtain a reliable contact between the handle 12 and the fingertips. Furthermore, an excessive depth would deprive the user of experiencing a soft, cushiony feel. On the other hand, a relatively small depth of the rounded portion 42 of the fins 40 can lead to an unreliable contact between the handle 12 and the fingertips.

The aspect ratio between the depth D of the rounded portion 42, as viewed in a direction transverse to longitudinal axis A-A, and a thickness T, as viewed in a direction parallel to the longitudinal axis A-A (FIG. 3), is critical to the desired compression of the outer layer 20. A preferred range of the aspect ratio (D:T) varies between 1.2 and 2 and should be always greater than the depth D. A particularly advantageous aspect ratio has been found to vary from about 1.4 to about 1.6. For example, the rounded portions 42 having a depth D from about 1.20 to about 1.25 millimeters and a thickness T from about 0.6 to about 1 millimeters have been found to provide ample compression and security of grip by the user. Experimental results show that the handle 12, which has the fins 40 made from a low stiffness elastomeric material and molded with the above disclosed range of the aspect ratio, provides the user with a superior soft, cushiony feel.

The density of the fins 40 that is the number of fins per centimeter is also important for obtaining a reliable contact between the fingertips and the handle 12. A preferred density includes from 7 to 9 ribs per centimeter. An axial spacing S (FIG. 3) between adjacent ribs can vary from about 0.6 to about 0.8 millimeters. Preferably, the fins 40 cover from about 50% to about 80% of the entire handle length (FIG. 3).

The fins 40 can be arranged in two continues rows 50 extending along opposite lateral segments 36 of the layer 20, as shown in FIG. 3. Alternatively, as shown in FIGS. 1 and 2, the fins 40 can be arranged along each lateral segment 36 in multiple groups, for example two groups 52 and 54, separated from one another along the axis A-A (FIG. 2) by a indentation 56. The fins 40 constituting each of the groups 52, 54 are each shaped and dimensioned in accordance with the inventive range of the aspect ratio D:T, as disclosed above. The indentation 56 is spaced from a front end 60 of the layer 20 at a distance between one-third (⅓) and one-half (½) of the entire length L of the handle 12 can be provided with ribs 58. It is possible to provide a top 62 (FIGS. 1, 2 and 3) of the handle 12 with the fins 40 (not shown) shaped and sized in accordance with the inventive range of aspect ratio D:T. Alternatively, the top 62 can have various projections 64 (FIG. 1 and 3) enhancing the grip on the handle.

The inner core 18 and the layer 20 are made from compatible moldable materials. The choice of the elastomeric material of the layer 20 determines the particular material suitable for the inner core 18 because of its needs for compatible operating conditions during molding. A suitable combination for the inner rigid core 18 employs PP, whereas the layer 20 is preferably made from a thermoplastic rubber such as Santoprene and Vyram. Other suitable materials that can be employed for manufacturing the inner rigid core 18 include ABS/SEBS (acrylonitrile butadiene styrene/Styrene-Ethylene-Butylene-Styrene).

Preferably, a method of manufacture of the handle 12 includes the injection molding provided in a two-step process in a single mold. This process provides for initially forming the inner core 18, which is typically molded of PP polymer, and then encompassing the inner core 18 with the layer 20, as shown in FIG. 5.

An alternative method of manufacture of the handle can be completed by an insert molding process wherein the inner core 18 is molded of the rigid polymer, ejected and placed into a second mold in which the moldable thermoplastic rubber encompasses the inner core.

Although, the above description is directed to a safety razor, it is understood that the fins 40 provided with the inventive range of the aspect ratio can be formed on the elastomeric material constituting a handle portion of any other hair-cut device, a brush, a tooth brush, and the like.

The present invention is not restricted to the specific embodiments of the specification and drawings, but also encompasses any modifications within the scope of the appended claims. What is claimed is:

1. A shaver handle comprising:
an elongated rigid inner core extending along a longitudinal axis; and
an elongated, compressible outer layer formed around the inner rigid core, the compressible outer layer being provided with a series of axially spaced fins having a substantially uniform aspect ratio D:T, wherein D is a depth of each individual fin viewed in a direction transverse to the longitudinal axis and T is a thickness of the individual fin viewed in a direction parallel to the longitudinal axis, the aspect ratio being greater than the depth D of the individual fin.

2. The shaver handle as claimed in claim 1, wherein the aspect ratio D:T varies from about 1.2 to about 2.

3. The shaver handle as claimed in claim 2, wherein the aspect ratio D:T varies from about 1.4 to about 1.6.

4. The shaver handle as claimed in claim 1, wherein the fins are spaced apart at an axial spacing varying from about 0.6 to about 0.8 millimeters.

5. The shaver handle as claimed in claim 4, wherein the fins cover from about 50 to about 80% of the entire length of the shaver handle.

6. The shaver handle as claimed in claim 1, wherein the compressible outer layer has an elongated, continuous outer segment bridging two elongated continuous lateral segments, each of the continuous lateral segments having a respective series of the fins extending laterally outward from the continuous lateral segment, the depth of each fin progressively decreasing from a greater depth to a smaller depth as the fin extends inwards from the continuous outer segment, whereas the depth D is the greater depth of the fin.

7. The shaver handle as claimed in claim 6, wherein each of the fins has a respective outer portion located adjacent to the continuous outer segment and having the greater depth D.

8. The shaver handle as claimed in claim 8, wherein the outer portion of the fin has a curved circumference, the greater depth D being defined as a radial distance between a tangent to the curved circumference and a center of the curved circumference lying on the respective lateral segment.

9. A safety razor comprising: a razor blade unit; and a elongated handle extending along a longitudinal axis and supporting the blade unit, the elongated handle including an inner, relatively incompressible core and an outer relatively compressible layer formed around the inner, relatively incompressible core, the relatively compressible layer having a series of axially spaced-apart fins, each of the fins being shaped and dimensioned to have an aspect ratio D:T, wherein D is a depth of the fin and T is an axial thickness of the fin, the aspect ratio being greater than the depth D of the fin.

10. The safety razor as claimed in claim 9, wherein each of the fins is shaped and dimensioned to have a greater depth and a smaller depth, the depth D being the greater depth.

11. The safety razor as claimed in claim 10, wherein the aspect ratio D:T varies from about 1.2 to about 2.

12. The safety razor as claimed in claim 10, wherein the aspect ratio D:T varies from about 1.4 to about 1.6.

13. The safer razor as claimed in claim 9, wherein the fins are spaced apart at a uniform axial spacing varying from about 0.6 to about 0.8 millimeters.

14. The safety razor as claimed in claim 13, wherein the fins cover from about 50 to about 80% of the entire length of the elongated handle.

15. The safety razor as claimed in claim 9, wherein the outer, relatively compressible layer is made from an elastomeric material and has an elongated, continuous outer segment bridging two continuous lateral segments, each of the continuous lateral segments having a respective plurality of the fins extending laterally outward from the continuous lateral segment.

16. The safety razor as claimed in claim 15, wherein each of the fins has the depth progressively decreasing from the greater depth D to the smaller depth as the fin extends inwardly from the elongated, continuous outer segment of the outer compressible layer in a direction transverse to the longitudinal axis.

17. The safety razor as claimed in claim 15, wherein each of the fins has a respective outer portion extending between the continuous outer and lateral segments of the outer layer and provided with the greater depth D.

18. The safety razor as claimed in claim 17, wherein the outer portion of the fin has a curved circumference, the greater depth D being defined as a radial distance between a tangent to the curved circumference and a center of the curved circumference lying on the respective lateral segment of the outer compressible layer.

19. The safety razor as claimed in claim 1, wherein the inner, relatively incompressible core includes an inner portion and an outer portion provided with a pair of legs, the inner and outer portions having a common outer part bridging the pair of legs which extend inward from the common outer part in a direction transverse to the longitudinal axis and angularly outward from the inner recessed portion.

20. The safety razor as claimed in claim 15, wherein the fins are arranged in multiple groups located along each of the lateral segment of the outer compressible layer, each of the lateral segments having at least one indentation separating adjacent groups of the fins, the at least one indentation being spaced from a front end of the handle attached to the razor blade unit at a distance varying from about a to about ½ of the entire length of the handle, the handle having a smooth curved shape in a direction parallel to the longitudinal axis.
